(19) United States
(12) Patent Application Publication
(10) Pub. No.: US 2018/0249317 A1
(43) Pub. Date: Aug. 30, 2018

(54) TERMINAL, NETWORK NODE, COMMUNICATION CONTROL METHOD AND NON-TRANSITORY MEDIUM

(71) Applicant: NEC CORPORATION, Tokyo (JP)

(72) Inventors: Toshiyasu KURASUGI, Tokyo (JP); Takashi TABE, Tokyo (JP); Hiroto OTSUKI, Tokyo (JP)

(73) Assignee: NEC CORPORATION, Tokyo (JP)

(21) Appl. No.: 15/754,472

(22) PCT Filed: Aug. 28, 2015
(86) PCT No.: PCT/JP2015/074385

§ 371 Date: Feb. 22, 2018

(51) Int. Cl. H04W 8/04; H04W 88/16; H04W 76/27; H04W 4/50; H04W 48/18; H04W 76/10

(52) U.S. Cl. CPC H04W 8/04; H04W 88/16; H04W 76/10; H04W 4/50; H04W 48/18; H04W 76/27

(57) ABSTRACT

A terminal includes a user interface that accepts an input of information used to determine whether to receive provision of an MEC service from an MEC server, or not, and a notification unit that notifies the network of information used by the network node to make a determination regarding provision of an MEC service from the MEC server.

### CROSS REFERENCE TO RELATED APPLICATIONS

This application is a National Stage of International Application No. PCT/JP2015/074385 filed Aug. 28, 2015.

### FIELD

The present invention relates to a terminal, a network node, a communication control method, and a non-transitory medium.

### BACKGROUND

Mobile edge computing (MEC) has been proposed in which a server is arranged in a vicinity of a mobile communication base station such as an LTE (Long Term Evolution) base station, or an access points. For example, various use cases have been proposed because high merits such as reduction of communication delay (latency) and reduction of bandwidth of a backhaul can be obtained by placing a MEC server close to a user (see Non-Patent Literature 1). Non-Patent Literature 1 discloses, for example, a system in which a video stream photographed by a camera is transcoded by an MEC server and transferred from the MEC server to a core network in a low bandwidth, a system in which a cache is provided in a core network, a packet from a contents source such as the Internet is temporarily cached, a packet is transmitted from the core network to a MEC server of an LTE base station using backhaul transfer of low-bandwidth, and stored in a local cache of the MEC server, and then transmitted to the terminal.

Non-Patent Literature 2 describes a technique for switching a route of access to the Internet to perform offloading.

In Patent Literature 1, a member terminal receives a home page from a common server device, displays it on an LCD (Liquid Crystal Display), and from a service selection icon included in the displayed homepage, accepts a selection input from the service selection icon, corresponding to a target information providing service of a user of this member terminal, and requests execution of the selected information providing service to the common server device. A user of the member terminal can receive a target information providing service from the common server device.

### Patent Literature 1

PTL 1: JP Patent Kokai Publication No. JP-H11-68823A

### [Non-Patent Literature 1]

“Mobile Edge Computing—Introductory Technical White Paper” (internet[Jul. 1, 2015 search]: http://portal.etsi.org/Portals/0/TBpages/MEC/Docs/Mobile-edge_Comp uting_-_Introductory_Technical_White_Paper_V1%2018-09-14.pdf>

### [Non-Patent Literature 2]

Internet white paper 2011, Internet association of the foundation corporation (supervised), Impress Japan Jul. 29, 2011, page 134

### SUMMARY

In an MEC service, an issue is that a continuity of a service due to movement of a terminal cannot be secured. For example, when the MEC service is provided by the base station, and when the terminal performs a hand-over between base stations due to the movement, there may be a situation where a continuity of the service cannot be secured. Under such a circumstance, providing the MEC service to the terminal may cause problems such as interruption of service, lowering of quality (such as QoE (Quality of Experience)), or the like, and there is a possibility that the degree of customer satisfaction may be significantly reduced.

By narrowing down a case where a service continuity is high, providing MEC service to the terminal may reduce a remarkable decrease in customer satisfaction (findings by the inventors of the present application).

The present invention was invented in view of the above problems, and its main object is to provide a terminal capable of selecting whether to receive an MEC service or not, provide a network node and a communication control method, and a non-transitory medium for controlling provision of an MEC service according to information from the terminal.

According to one aspect of the present invention, there is provided a terminal comprising:

a user interface that accepts an input of information used for determining whether to receive an MEC service from an MEC server, or not, and

a notification unit that notifies a network of the information used by a network node to make a determination regarding provision of an MEC service from the MEC server.

According to another aspect of the present invention, there is provided a network node comprising:

a reception unit that receives from a terminal information used to make a determination of provision of an MEC service from an MEC server;

a determination unit that determines a terminal to which the MEC service is provided from the MEC server; and

a connection setting unit that sets connection between a terminal to which the MEC service is provided and the MEC server.

According to yet another aspect of the present invention, there is provided a communication control method of a terminal in a network system including the terminal and a network node, the method comprising:

accepting an input of information used to determine whether to receive provision of an MEC service from an MEC server, or not; and

notifying the network of information used by the network node to make a determination regarding provision of an MEC service from the MEC server.

According to yet another aspect of the present invention, there is provided a communication control method of a network node in a network system including a terminal and the network node, the method comprising:

receiving from the terminal information used for determining an MEC service from an MEC server;

determining, based on the information received, a terminal to which an MEC service is provided from the MEC server; and

setting connection of a terminal, to which the MEC service is provided, with the MEC server.

According to still another aspect of the present invention, there is provided a non-transitory computer-readable medium storing therein a program constituting a terminal to execute processing comprising:

accepting an input of information used to determine whether to receive provision of an MEC service from an MEC server, or not; and

notifying the network of information used by the network node to make a determination regarding provision of an MEC service from the MEC server.

According to still another aspect of the present invention, there is provided a non-transitory computer-readable medium storing therein a program constituting a network node to execute processing comprising:

receiving from the terminal information used for determining an MEC service from an MEC server;

determining, based on the information received, a terminal to which an MEC service is provided from the MEC server; and

setting connection of a terminal, to which the MEC service is provided, with the MEC server.

According to the present invention, the non-transitory computer-readable medium may be a recording medium such as a semiconductor memory, a magnetic recording medium, or a storage such as a CD (Compact Disk)-ROM (Read Only Memory) and so forth.

According to the present invention, it is possible for a terminal to select whether or not to receive an MEC service. Still other features and advantages of the present invention will become readily apparent to those skilled in this art from the following detailed description in conjunction with the accompanying drawings wherein only exemplary embodiments of the invention are shown and described, simply by way of illustration of the best mode contemplated of carrying out this invention. As will be realized, the invention is capable of other and different embodiments, and its several details are capable of modifications in various obvious respects, all without departing from the invention. Accordingly, the drawing and description are to be regarded as illustrative in nature, and not as restrictive.

### BRIEF DESCRIPTION OF THE DRAWINGS

FIG. 1 is a diagram for schematically explaining an example of a system according to an example embodiment of the present invention.

FIG. 2 is a diagram for explaining a configuration of a terminal according to an example embodiment of the present invention.

FIGS. 3A to 3D are diagrams for explaining an example of a display screen of a terminal according to an example embodiment of the present invention.

FIGS. 4A to 4D are diagrams for explaining an example of a display screen of a terminal according to an example embodiment of the present invention.

FIG. 5A is a diagram schematically illustrating an example of a configuration of a terminal according to an example embodiment of the present invention.

FIG. 5B is a diagram schematically showing an example of information stored in the memory.

FIG. 6A and FIG. 6B are diagrams illustrating a notification unit of a terminal.

FIG. 6C is a diagram for explaining the operation of the terminal of FIG. 6B.

FIG. 7 is a diagram schematically illustrating an example of a configuration of a base station according to an example embodiment of the present invention.

FIG. 8 is a diagram schematically illustrating an example of an example embodiment of the present invention.

FIG. 9 is a diagram schematically illustrating another example of an example embodiment of the present invention.

FIG. 10 is a diagram schematically illustrating another example of an example embodiment of the present invention.

FIG. 11 is a diagram schematically illustrating still another example of an example embodiment of the present invention.

FIG. 12 is a diagram illustrating an example of a message of an example embodiment of the present invention.

FIG. 13 is a diagram illustrating another example of a message of an example embodiment of the present invention.

FIG. 14 is a diagram illustrating still another example of a message of an example embodiment of the present invention.

### DETAILED DESCRIPTION

The following describes example embodiments of the present invention with reference to the drawings. According to one of several modes of the present invention, it is possible for a terminal to set whether or not an MEC is used. A terminal that can be guided to MEC may be selectively guided to an MEC service. An Evolved Packet System (EPS) which accommodates LTE and System Architecture Evolution (SAE) will be described mainly in several embodiments described below. However, these embodiments are not limited to EPS, and may be also applied to other mobile communication networks or systems such as 3GPP (3rd Generation Partnership Project) UMTS (Universal Mobile Telecommunications System), 3GPP2 CDMA2000 system (1×RTT (Radio Transmission Technology). HRPD (High Rate Packet Data)), global system for mobile communications (GSM (registered trademark))/General packet radio service (GPRS) system, WiMAX (Worldwide Interoperability for Microwave Access), and so forth.

### <System Configuration>

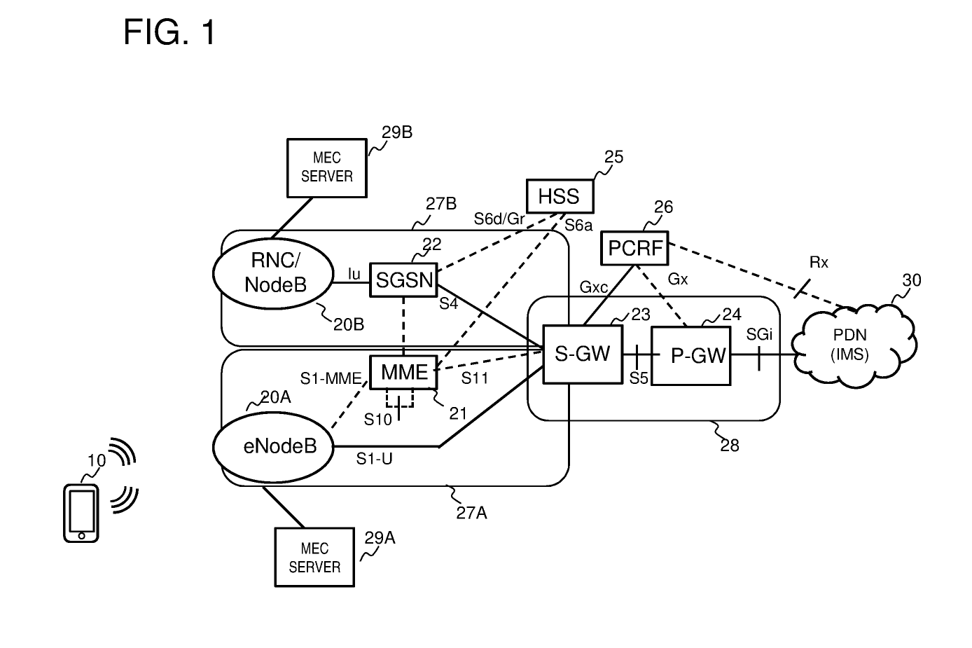

FIG. 1 is a diagram schematically showing an example of a system configuration of an example embodiment. Referring to FIG.>1, an LTE-compatible terminal (User Equipment: UE) 10 connects via an LTE base station (evolved Node B: eNode B) 20 A, an S-GW (Serving Gateway) 23, a P-GW (Packet Data Network) Gateway) 24 to the packet data network (PDN) 30. When the terminal 10 is compatible with 3G (3rd Generation), the terminal 10 connects via a base station (Node B)/Radio Network Controller (RNC) Packet Radio System) of UTRAN (Universal Terrestrial Radio Access Network) to an SGSN (Serving GPRS (General Generation) and connects to the packet data network (PDN) 30 from the SGSN 22 via the S-GW 23 and the P-GW 24. In FIG. 1, an MME (Mobility Management Entity) 21 cooperates with a HSS (Home Subscriber Server) 25 that holds a subscriber profile to authenticate a user, mobility management of the terminal 1, session management such as NAS (Non-Access Stratum) signaling and the like. Evolved Packet System (EPS) bearer management, and the like. The S-GW 23 exchanges user data with the base station, and sets and releases a communication route between the P-GW 24 and the S-GW 23. The P-GW 24 is connected to a packet data network (PDN) 30 such as an IMS (IP (Internet Protocol) Multimedia Subsystem) and the Internet. The P-GW 24 also allocates an IP (Internet Protocol) address (private IP address) to the terminal 10. A PCRF (Policy and Charging Rules Function) 26 determines policy control such as QoS (Quality of Service) and a charging control rule(s). The P-GW 24 and the S-GW 23 perform policy control on a packet basis, for example, based on notification information from the PCRF 26. In FIG. 1, symbols S1, S4, S5, and so forth designated to lines between respective nodes represent interfaces. A dashed line connecting each node represents a control plane (C-Plane), and a solid line represents a signal (data) of the user plane (U-Plane). In FIG. 1, two servers 29A and 29B respectively connected to the eNodeB 20A and the RNC/NodeB 20B are shown as MEC servers, but the MEC server may be connected to either one, or to another network node. 27A is an LTE radio access accommodation network, 27B is a 3G radio access accommodation network, and 28 is a core network common to the EPC LTE radio access accommodation network 27A and 3G radio access accommodation network 27B.

According to one of several modes of the present invention, the terminal 10 may be configured to accept an input of information used for determining whether or not to receive provision of an MEC service and notify a network of information used by a network node to make a determination regarding provision of an MEC service.

According to one of several modes of the present invention, a network node (for example, a base station or a node such as MME) may receive, from the terminal 10, information used to make a determination regarding provision of an MEC service, determines a terminal to which the MEC service is provided, and sets connection between the terminal to which the MEC service is provided and an MEC server.

According to one of several modes of the present invention, the MEC servers 29A/29B communicatively connects to the terminal 10 may be connected to the packet data network 30 such as the Internet via the core network 28. Alternatively, the MEC servers 29A/29B may be connected to the packet data network 30 such as the Internet without going through the core network 28.

Furthermore, the MEC service may not be directed to the packet data network (PDN). For example, the MEC servers 29A/29B may be located in a private network of the carrier connected to the base station. In this case, communication is performed between the terminal and the MEC server, and there is a case in which bearer setup or the like for connection to the PDN in the core network may be unnecessary. As an example, the MEC server 29A/29B may function as a server (edge server) that provides a content delivery service (CDS) that delivers contents or the like that the MEC server 29A/29B holds to the terminal 10. When the contents requested from the terminal 10 are not held (cached) in the MEC server 29A/29B, the MEC server 29A/29B may acquire the contents from an origin server on the Internet or the like and deliver the contents from a cache to the terminal 10. In the present invention, the MEC service, as a matter of course, is not limited to the content delivery service. For example, the MEC server may be a server for an Augmented Reality (AR) service, a server for a service that provides advertisements according to location information of a user, or a server for a service that performs video analysis, that is, the server may be a server for providing various services.

In the following, the terminal of the example embodiment will be described first, then the network node (for example, base station) will be described.

### <Terminal Configuration>

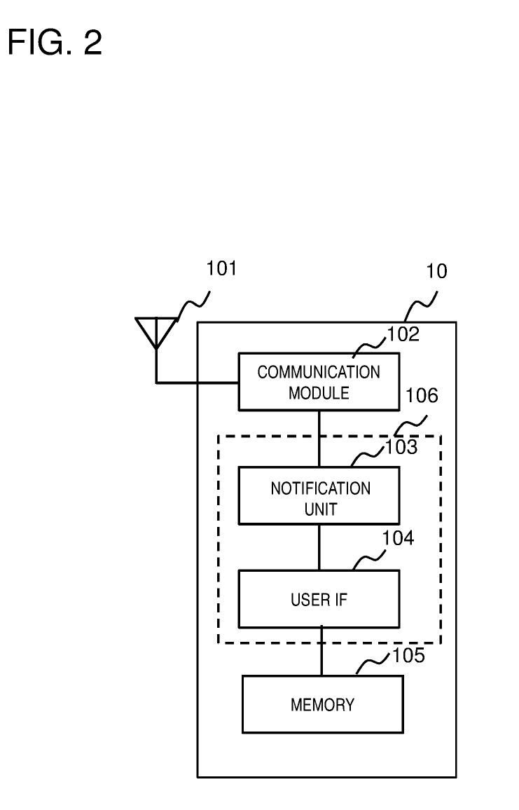

FIG. 2 is a diagram schematically illustrating an example of a configuration of the terminal 10 of the example embodiment. Referring to FIG. 2, the terminal 10 includes an antenna 101 for wireless transmission of information to and from a base station (not shown), a communication module 102 compliant with LTE or 3G, a user interface (user IF) 104 that accepts an input of information used to determine whether to receive provision of an MEC service or not, a notification unit 103 that notifies a network of information used to determine whether an MEC service is provided by a network node, a memory 105 that stores various kinds of information. The communication module 102 may include an RF (Radio Frequency) transceiver (not shown), a base band unit that performs modulation and demodulation of an intermediate frequency signal, and a communication controller (not shown) that performs communication control. The RF transceiver performs frequency conversion of a transmission intermediate frequency signal, and power amplification of the frequency converted signal for transmission from the antenna 101. The RF transceiver amplifies a signal received from the antenna 101 and performs frequency conversion of the received signal to an intermediate frequency signal. Note that the communication module 102 may be freely switchable between LTE and 3G. In the case where the network node is a base station, the notification unit 103 transmits, from the communication module 102 to the base station, information used to make a determination regarding provision of an MEC service.

The memory 105 may include a semiconductor storage such a DRAM (Dynamic Random Access Memory), or ROM (Read-Only Memory) such as EEPROM (Electrically Erasable Programmable Read-Only Memory), or a HDD (Hard Disk Drive). Although not particularly limited, at least a part of each processing of the notification unit 103 and the user IF 104 may be implemented by a program executed by a processor 106 such as a CPU (Central Processing Unit). In this case, although not particularly limited, the memory 105 may store the program. The processor 106 may read the program and execute the program.

### <User IF>

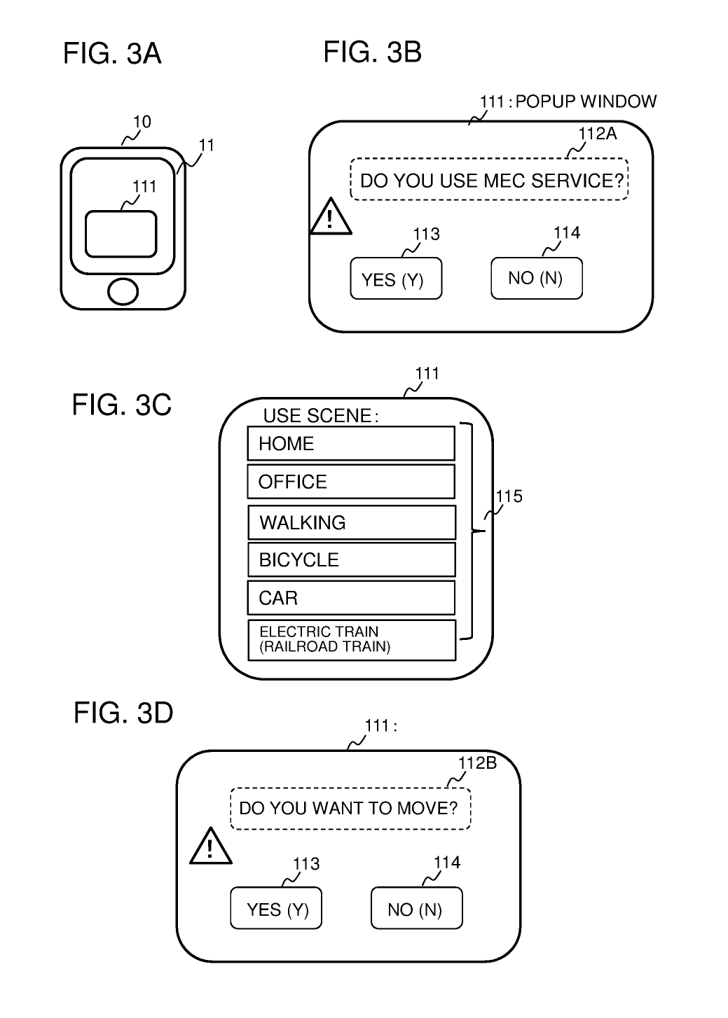

Next, regarding the user IF 104 of FIG. 2, some display screens output by the user IF 104 will be described as an example, with reference to FIG. 3 (but not limited to the following).

FIG. 3A is a diagram illustrating a state in which a pop-up 111 is displayed on a display screen 11 of the terminal 10. Pop-up (also referred to as “pop-up screen” or “pop-up window”) designates automatically displaying another window or the like, on a foreground on the screen such as a web browser and a screen displayed. Pop-up is used to convey a message to a user and prompt a specific operation by a user. The display form is, as a matter of course, not limited to the pop-up screen.

FIG. 3B is a diagram illustrating the pop-up 111 of FIG. 3A. As illustrated in FIG. 3B, a message 112A such as “Do you use MEC?” may be displayed on the pop-up 111. When using the MEC, a user of the terminal 10 selects (taps) a “Yes” button 113 and, when not using the MEC. The user selects a “No” button 114. Buttons arranged on this screen are not limited to “yes” or “no”, but may be provided with, for example, a “cancel” button.

Although not particularly limited, regarding a timing at which the pop-up 111 is output to the display screen 11 of the terminal 10, for example, the following may be listed.

In the terminal 10.
when a target application of the MEC service (application that uses a service provided by the MEC server) starts up;
when the terminal 10 is turned on;
when the terminal 10 is served in a new cell;
when the terminal 10 moves in a tracking area (TA) (in a case of UTRAN, the terminal 10 moves in a routing area (RA) or a location area (LA));
when the terminal 10 moves outside a tracking area list (TAL) to transmit a TAU request (Tracking Area Update Request) (RAU request or LAU request in UTRAN);
when PDN (Packet Data Network) connection is established, or EPS (Evolved Packet System) bearer is established.

The PDN connection is a logical communication path from the terminal 10 to the P-GW 24. The EPS bearer is a logical path established between the P-GW 24 and the terminal 10 for each terminal 10 for transfer of an IP (Internet Protocol) packet.

As illustrated in FIG. 3C, for example, in the pop-up 111 displayed on the terminal 10, as choices of a usage scene of the terminal 10, there are displayed “House”, “Office”. “Walk”. “Bicycle”, “Car”, “Train”, and the like on a menu bar 115, and the user may select either. In this case, bicycles, cars, trains and the like indicate that the terminal 10 is in a moving condition.

Alternatively, as illustrated in FIG. 3D, a message 112 B of “Do you move?” is output to the pop-up 111 displayed on the terminal 10, and a user selects a “Yes” button 113 or a “No” button 114. In this case, selecting the “Yes” button 113 by the user corresponds to selection of not receiving MEC service (not using MEC service) in the terminal 10.

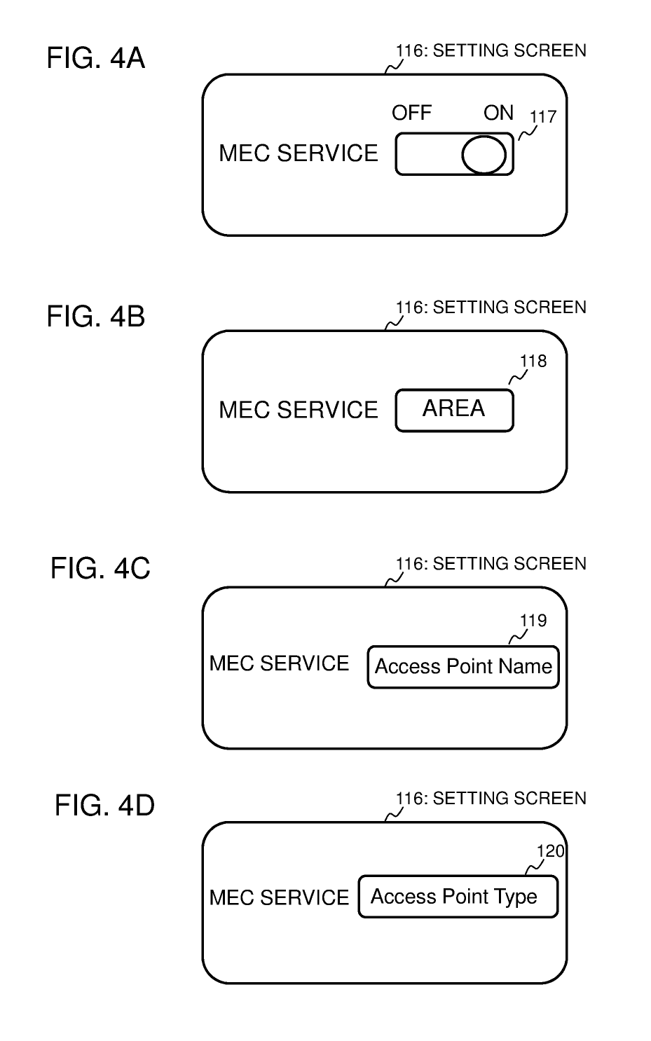

Alternatively, as another display form of the user IF 104, for example, as illustrated in FIG. 4A, setting items such as whether or not to use the MEC server may be provided on a setting screen (setup screen) 116 used for setup of a network.

Alternatively, as illustrated in FIG. 4B, setting such as using the MEC service may be performed only within an area selected on the setting screen 116. When an area button 118 on the setting screen 116 is tapped, an area selection menu (not shown) may be displayed on the screen, and in the area selection menu, prefectures, municipalities, and so forth, may be appropriately selected.

Further, as illustrated in FIG. 4C, on the setting screen 116, a setting field 119 for an access point name (APN) is prepared in a dedicated manner for the MEC service, and an APN (PDN connecting to the Internet, IMS, or the like) may be set. On the setting screen, an APN name is set and the setting is saved. APN is a DNS (Domain Name System) naming scheme that describes an access point to a packet data network.

Further, as illustrated in FIG. 4D, an access point type (Access Point Type) 120 may be prepared for MEC service identification and the access point type may be set. The access point type (APN type) is a type of communication to be made to the APN. For example, the APN type includes default setting, supl (secure user plane location), agps (assisted gps (global positioning system)), mms (multi-media message), and the like.

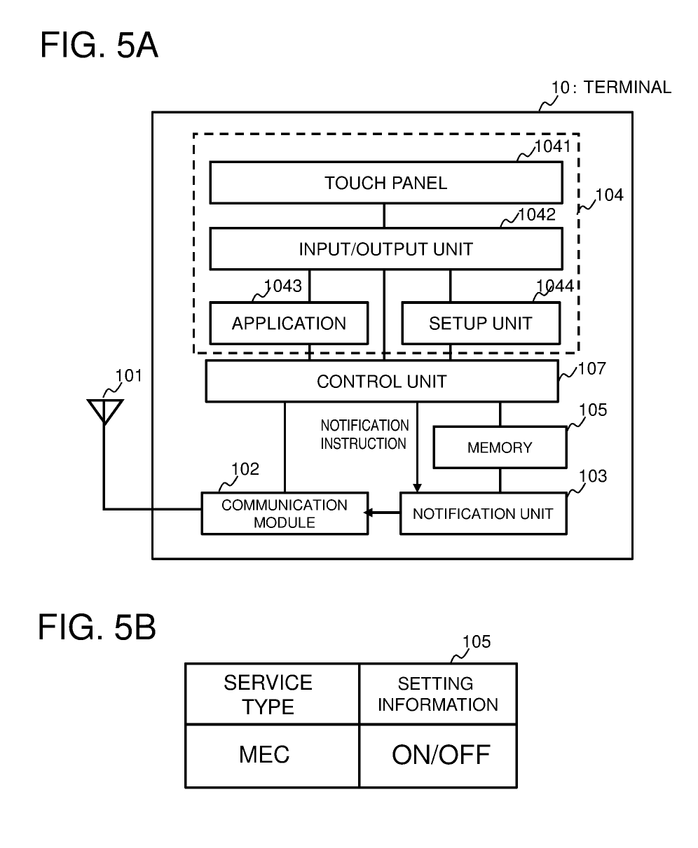

Next, a configuration example of the user IF 104 of the terminal 10 in FIG. 2 will be described with reference to FIG. 5A. Referring to FIG. 5A, the terminal 10 includes a touch panel 1041, an input/output unit 1042 that controls input/output to/from the touch panel 1041, and an application 1043 that uses the MEC service and displays via an input/output unit 1042, screens as illustrated in FIGS. 3B to 3D, a setup unit 1044 that displays a setting screens as illustrated in FIGS. 4A to 4 D, and sets up a network at the terminal 10, and a control unit 107 that controls activation and so forth of the application 1043, the setup unit 1044 and so forth and controls to store input information from the touch panel 1041 in the memory 105. In FIG. 5A, the touch panel 1041, the input/output unit 1042, the application 1043, and the setup unit 1044 constitute the user IF 104 in FIG. 2.

In a case such as,

when the terminal 10 is powered on,
when the terminal 10 is served in a new cell based on a signal transmitted/received by the communication module 102.
when the terminal 19 moves in another tracking area (TA) (when moving in another routing area (RA) in UTRAN), when the terminal 10 transmits a tracking area update request (TAU (Tracking Area Update) Request).
when a PDN connection is established, or
when an EPS bearer is established, the control unit 107 may control the input/output unit 1042 to output the pop-up screen 111 described with reference to FIGS. 3A to 3D, via the application 1043 or directly, Further, when the communication module 102 of the terminal 10 transmits a NAS message such as a tracking area update request (TAU (Tracking Area Update) Request) or an attach request, the control unit 107 may insert information used to make a determination regarding provision of an MEC service into the NAS message and notifies the notification unit 103 of the information by using the NAS message. Alternatively, when receiving the notification that the MEC service can be provided from the network side, the control unit 107 may control, via the application 1043 or directly, the input/output unit 1042 to output the pop-up screen 111 described with reference to FIGS. 3 A to 3D.

FIG. 5B is a diagram illustrating a data format of the memory 105 that stores the presence/absence (flag information) of the use of the MEC service that is set on the setting screen as illustrated in FIG. 4A. In the memory 105, a service type and setting information are stored in association with each other.

### <Terminal: Notification Unit>

Next, the notification unit 103 (FIG. 2) in the terminal 10 will be described. The notification unit 103 receives information to be used for determining whether to receive provision of an MEC service or not, and notifies a network node (for example, a base station) of information used to make a determination regarding provision of an MEC service. More specifically, the notification unit 103 transmits information on whether or not to use the MEC service entered via the application 1043 in FIG. 5A, or information on whether or not to use the MEC service stored in the memory 105 (FIG. 5B) via the control unit 107, transmits the information to a network (base station) via the communication module 102 and the antenna 101, including the information in a predetermined NAS message or the like.

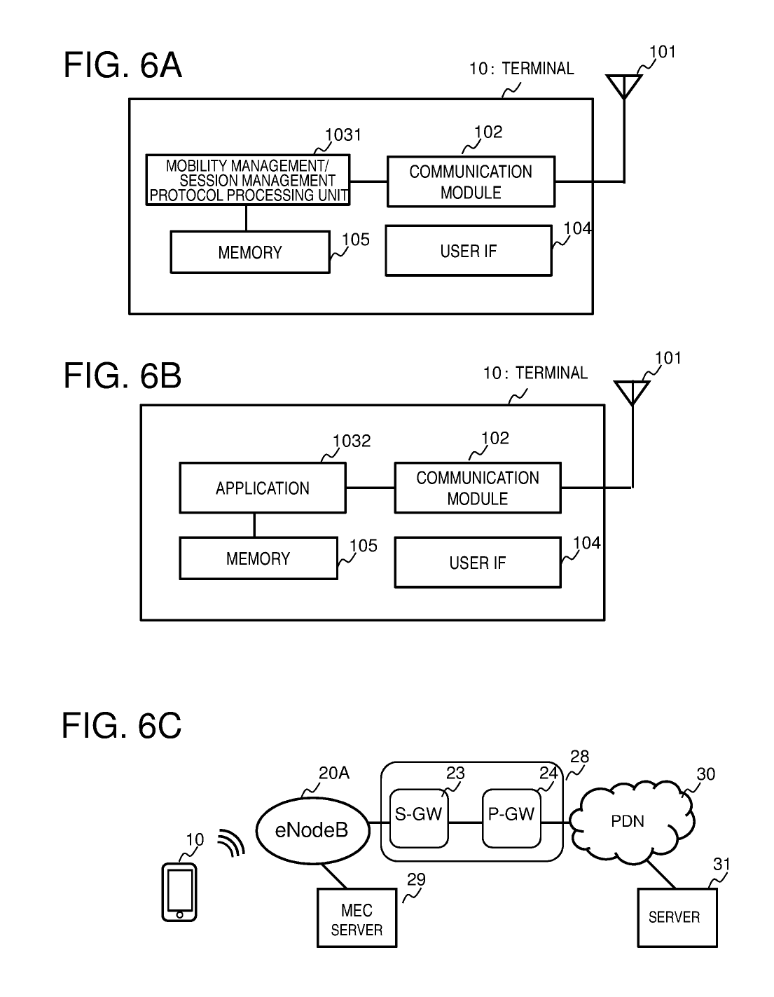

FIG. 6A is a diagram illustrating an example in which the notification unit 103 in FIG. 2 is configured with a mobility management/session management protocol processing unit 1031. Mobility management and session management are two main functions of NAS (Non-Access Stratum). A message in the NAS layer is a control message that is transmitted and received transparently between the terminal and the MME (SGSN). The NAS message sent from the terminal 10 to the MME 21 (SGSN 22) includes a request message such as attach request, detach request, session (bearer) request, and location update request, or the like. In the case of Evolved Packet System (EPS), the NAS request message from the terminal (UE), for example, includes at least one of
Attach request (Attach Request),
Service request (Service Request),
PDN connectivity request (PDN connectivity request),
Bearer resource allocation request (Bearer Resource Allocation Request),
Bearer Resource Modification Request (Bearer Resource Modification Request)
A tracking area update request (TAU (Tracking Area Update) Request)
Routing area update request (RAU (Routing Area Update) Request) and the like.

On the other hand, the NAS message transmitted from the MME 21 (SGSN 22) to the terminal 10 includes an acceptance (ACCEPT) message and a rejection (REJECT) message for these NAS request messages. Mobility management between a E-UTRAN terminal and a network is controlled by a protocol of a NAS layer of a C-Plane of the MME. A common procedure of mobility management between the terminal of the E-URAN and the MME includes assignment of GUTI (Global Unique Temporary Identity: temporary terminal identifier assigned to a terminal (UE) by an MME), authentication, security mode control, identification of a terminal (UE) and so forth, and includes, in addition to attachment, detachment, location registration area update (TAU), service request, paging, NAS message transfer and so forth as EMM (EPS Mobility Management) connection management.

In the present embodiment, the mobility management/session management protocol processing unit 1031 of the terminal 10 may insert, in a tracking area update request (TAU Request), information input to the user IF 104 from the screen as illustrated in FIGS. 3B to 3D. When the terminal 10 moves to a new tracking area (TA) and the new tracking area (TA) is not included in a tracking area list (TA-List) configured for the terminal, the terminal sends a tracking by sending a tracking area update request (TAU Request) message, thereby a TAU procedure being started. However, when the terminal enters into a new tracking area, which is included in the tracking area list (TA-List) configured for the terminal, the terminal may not transmit a tracking area update request (TAU Request).

According to the present embodiment, a field for sending usage information of the MEC service may be newly added in the tracking area update request (TAU Request). The TAU Request message includes information elements (IE) such as UE Core Network Capability, MS Network Capability, old GUTI (Global Unique Temporary Identity). Old GUTI type, last visited TAI (Tracking Area Identity), active flag. EPS bearer status, P-TMSI Information items such as Packet-Temporary Mobile Subscriber Identity Signature, additional GUTI, eKSI (Key Set Identifier in E-UTRAN), NAS sequence number. NAS-MAC (Message Authentication Code). KSI, Voice domain preference and UE's usage configuration, and so forth.

In the mobility management/session management protocol processing unit 1031 of the terminal 10, information input to the user IF 104 from the screen illustrated in FIGS. 3B to 3D may be one bit indicating whether or not the terminal can be guided to the MEC service, in a tracking area update (TAU) request message. Alternatively, as illustrated in FIG. 3C, bits indicating a usage scenario (when the number of used scenes is 8, 3 bit) may be used. Further, for example, the control unit 107 in the terminal 10, may convert with respect to a part of usage scenes (for example, walking, bicycle, car, or train each expected to move) to bit indicating that the terminal is not guided to the MEC service, and converts other usage scenes to a bit indicating that the terminal can be guided to the MEC service.

In the present embodiment, in order to send usage information of the MEC service, the mobility management/session management protocol processing unit 1031 may send information indicating whether or not the terminal may be guided to the MEC service, using an attach request message, instead of the TAU request. In the case of transmitting information on use/non-use of the MEC service by an attach request, the configuration may preferably be done on the configuration screen (see FIG. 4) in the terminal 10.

Furthermore, in the present embodiment, the mobility management/session management protocol processing unit 1031 may use a service request (Service Request) in order to send usage information of the MEC service. The service request is an EMM (EPS Mobility Management) connection management procedure that connects the terminal 10 to the network. The EMM connection management procedure is started from the terminal 10, or by transmitting paging to the terminal 10 from the network side and starts an establishment of a NAS signaling connection.

Alternatively, in the present embodiment, the mobility management/session management protocol processing unit 1031 may place, on the NAS message, usage information of the MEC service indicating whether or not the terminal 10 can be guided to the MEC service. For example, information of an access point name (APN) and an access point type (APN Type) can be placed on the NAS message of a session management protocol without changing processing function of the session management protocol.

In the present embodiment, the mobility management/session management protocol processing unit 1031 of the terminal 10 may transmit indicating whether or not the terminal 10 may be guided to the MEC service, not by using a part of an attach procedure, but by using a PDN connectivity request message (standalone Type), as a session management procedure, information, for example.

The PDN connectivity request transmitted to the MME as a NAS message from the terminal 10 includes an APN, a PDN address and so forth. When this APN coincides with an APN in FIG. 3C, the mobility management/session management protocol processing unit 1031 of the terminal 10 transmits information indicating whether or not the terminal 10 may be guided to the MEC service. Further, the mobility management/session management protocol processing unit 1031 of the terminal 10 may transmit information indicating whether or not the terminal 10 may be guided to the MEC service by using a bearer resource allocation request message or the like, as a session management procedure.

In EPS, PDN connection and EPS bearer are introduced in order to define IP connectivity between a terminal and a PDN. When it is needed to cope with a specific QoS (Quality of Service) or the like, a dedicated EPS bearer is established as a PDN connection, in addition to a default EPS bearer that is created when PDN connection is established.

Alternatively, as illustrated in FIG. 6B, instead of a communication protocol based on a NAS message or the like, for example, in the terminal 10, after establishment of the PDN connection, the application 1032 transmits to a server of a packet data network (PDN) information indicating whether or not the terminal 10 may be guided to the MEC service, and the server may notify a base station of the information indicating whether or not the terminal 10 may be guided to the MEC service by some means.

In this case, as illustrated in FIG. 6C, the information (User plane data) indicating whether or not the terminal 10 may be guided to the MEC service is transmitted from the terminal 10, via the base station 20 A, the S-GW 23 and P-GW 24 of the core network 28, to the server 31 of the PDN 30. Upon reception of the information, the server 31 transmits to the base station 20A control data for notifying information indicating whether or not the terminal 10 can be guided to the MEC service. At that time, the server 31 may transmit the control data to the P-GW 24 or the like, and the P-GW 24 may notify the information to the base station (eNodeB) 20A via the S-GW 23.

### <Network Node: Base Station>

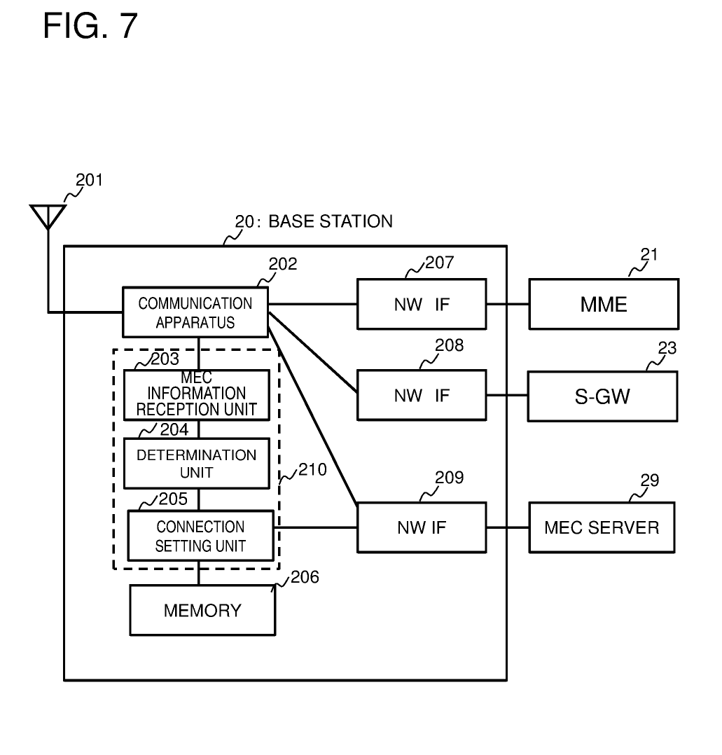

FIG. 7 is a diagram for explaining a base station as a network node. Referring to FIG. 7, the base station 20 includes an antenna 201, a communication device 202 including a radio unit and a baseband processing unit, an MEC information reception unit 203, a determination unit 204, a connection setting unit 205, a memory 206, and Network (NW) interfaces 207, 208, and 209 connected to the MME 21, the S-GW 22, and the MEC server 29, respectively. The NW interface 207 is an interface of the base station 20A on a side of the MME 21 in FIG. 1 and corresponds to S1-MME of the control plane (C-Plane). The NW interfaces 208 and 209 correspond to S1-U which is an interface of the base station 20A on a side of the S-GW 23 in FIG. 1.

The MEC information reception unit 203 obtains information used for judging that the MEC service will be provided, from the data that is received from the terminal 10 by the communication device 202. The determination unit 204 determines based on the acquired information, a terminal to which the MEC service is provided. The connection setting unit 205 establishes a connection between the terminal 10, which is determined by in the determination unit 204 to be a terminal to which the MEC service is provided, and the MEC server 29. According to setting in the connection setting unit 205, the MEC server 29 connects to the communication device 202 via the network interface 207, and transmits or receives data to/from the terminal 10. The base station 20 may notify the terminal that the base station 20 is connected to the MEC server 29 (notification that the MEC service can be provided). In FIG. 7, the base station 20 and the MEC server 29 are illustrated as separate units, but the base station 20 and the MEC server 29 may be integrated in one unit.

The MEC information reception unit 203 extracts a predetermined bit field of the NAS message transmitted from the terminal 10, for example, and obtains information used to make a determination regarding provision of an MEC service.

In a case where the information used to make a determination regarding provision of an MEC service is a flag indicating whether MEC service is available or not, the determination unit 204 determines presence or absence of MEC service provision according to a of the flag.

When the information transmitted from the terminal 10 is not simple permission information, as in a usage scene, for example, regarding a user in “home” or “office”, it may be determined that they will not move and that the MEC service can be provided. On the other hand, in a case of “walk”. “bicycle”, “car”, “train”, or the like, it may be determined that MEC service provision is not permitted. Also, in a case of a C-RAN (Centralized Radio Access Network) or a base station with a large coverage, when a usage scene is “walking” or “bicycle”, it may be determined that the MEC service can be provided. It is noted that the C-RAN is a network (RAN) in which base-band units (BBU) of the base stations are collected in a central office, and one radio control unit controls operation of a plurality of base stations.

Based on the information received, the connection setting unit 205 establishes connection between the terminal 10 determined to use the MEC service and the MEC server 29 which is arranged close to a network node (for example, base station) or integrated with the network node.

Note that the memory 206 may be a semiconductor storage such as DRAM (Dynamic Random Access Memory) or ROM (Read-Only Memory) such as EEPROM (Electrically Erasable Programmable Read-Only Memory), a HDD (Hard Disk Drive), a CD (Compact Disk), a DVD (Digital Versatile Disk), or the like. Although not particularly limited, at least a part of each processing of the MEC information reception unit 203, the determination unit 204, and the connection setting unit 205 may be realized by a program executed by the processor 210 such as a CPU. In this case, although not particularly limited, the program may be stored in the memory 206 and the processor 210 may read and execute the program.

The following descries several examples in which the MEC information reception unit 203 of the base station 20 is configured to perform processing of the mobility management/session management protocol described with reference to FIG. 6A, with respect to the terminal, and analyze MEC service information (such as whether the terminal can use/not use the MEC service) included in a NAS message to connect the terminal with the MEC server.

### <Example of Tracking Area Update Request>

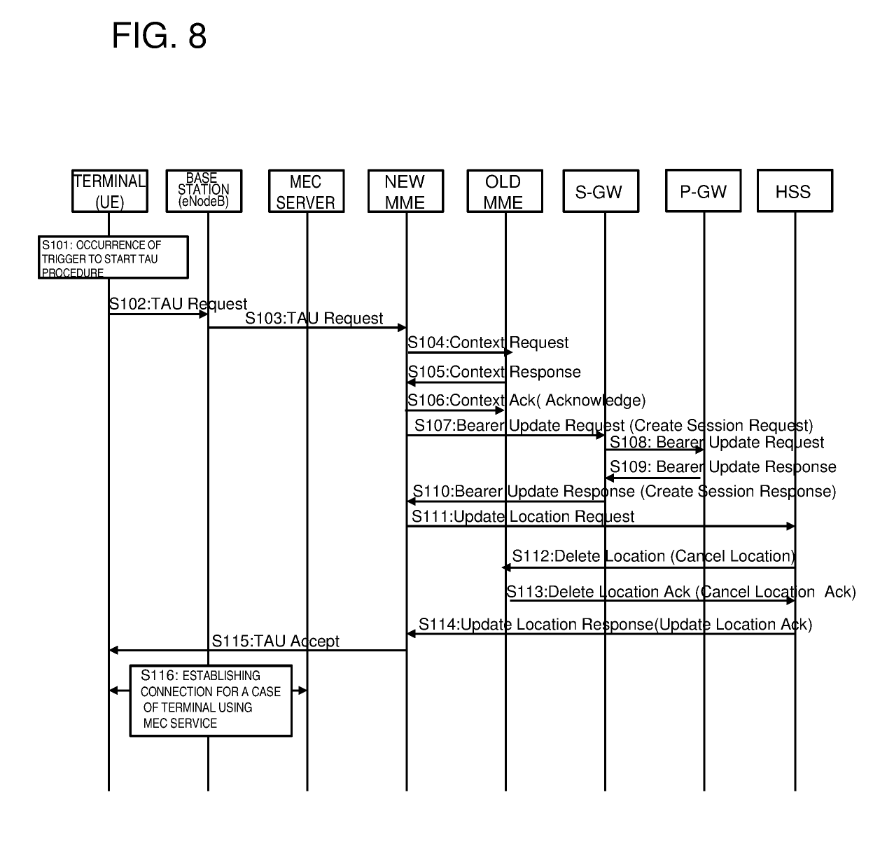

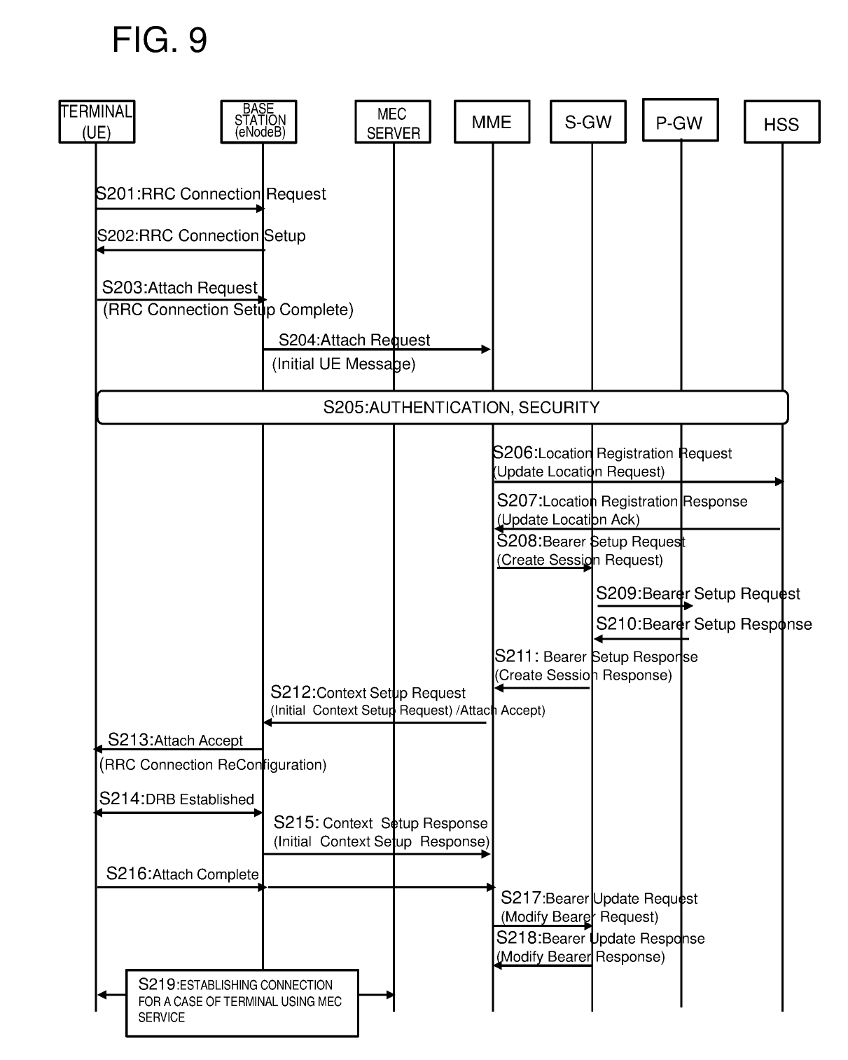

As illustrated in FIG. 8, for example, a predetermined field of a tracking area update request (TAU Request) transmitted from a terminal (UE) to a base station (eNodeB) may be used as information that the MEC information reception unit 203 of the base station analyzes to obtain information used to make a determination regarding provision of an MEC service. It is noted that the terminal (UE), the base station (eNodeB), the MEC server, the MME, the S-GW, the P-GW, and the HSS in FIG. 8 correspond respectively to 10, 20A, 29A. 21, 23, 24, (this also applies to FIGS. 9 to 11 to be described later).

FIG. 8 corresponds to a case where the terminal (UE) moves across the tracking area (TA), the MME becomes a new MME but the S-GW does not change. When a trigger for starting a TAU procedure occurs, such as when the terminal (UE) moves across tracking areas (TA) (S101), the terminal (UE) transmits a TAU Request to the base station (eNodeB) (S102). The base station (eNodeB) transmits the TAU Request to a new MME (S103). The new MME transmits a context request to an old MME (S104), obtains information on the terminal (UE) from the old MME (S105), and transmits a context acknowledge to the old MME (S106). The new MME performs a bearer update request (Create Session Request) to the S-GW (S107), sets a bearer between the S-GW and a P-GW (S108-S109), receives a bearer update response from the S-GW (S110). Further, the new MME requests an HSS to update a location (S111 to S114), and transmits a TAU Accept indicating acceptance of the tracking area update request to the terminal (UE) (S115).

In the base station (eNodeB), the information included in the TAU Request transmitted from the terminal (UE) in step S102 is stored in the memory 206, the determination unit 204 analyzes a bit field of the TAU Request. When the terminal (UE) is capable of being provided with the MEC service, connection between the terminal (UE) and the MEC server can be established (S 116). It is a matter of course that the connection setup processing between the terminal (UE) and the MEC server in the base station (eNodeB) is not limited after the transmission of a TAU Accept. Depending on a service(s) to be provided, the MEC server may be connected to the packet data network (PDN) via the P-GW of the core network.

In FIG. 8, when the MEC service is available, it is preferable that steps (or a part thereof) from step S103 to step S114 may are virtually executed between the base station and the MEC server, as the processing of S116. The reason is that, when the MEC service is available, an actual service is not guided to the packet data network (PDN), so processing (or part thereof) in the core network becomes unnecessary. Although it is redundant, the steps from S103 to S114 (or a part thereof) are also executed, but it is also possible to virtually execute equivalent processing between the base station and the MEC server. In the former case, the base station (eNodeB) preferably returns a TAU Accept in step S115 in place of the new MME.

It is noted that the base station (eNodeB) does not necessarily analyze the information used determining whether the MEC service is provided to the terminal (UE). For example, when the new MME that receives a TAU Request, and transmits a notification to the base station. In this case, this notification may be included in the TAU Accept of step S115 or may be notified as another message. In addition, in the case where the MEC service is available, the step (or a part thereof) of steps S104 to S114 may be executed virtually between the base station and the MEC server. The reason is that in a case where the MEC service is available, an actual service is not guided to the core network (packet data network), so that these processing (or parts thereof) are unnecessary.

### <Example of Attach Request>

As illustrated in FIG. 9, for example, the MEC information reception unit 203 of the base station analyzes a predetermined field of an Attach Request message transmitted from the terminal (UE) to the base station (eNodeB), Information to be used for determining whether to receive provision of an MEC service is acquired. Before an attach request (Attach Request) (S203), the terminal transmits an RRC (Radio Resource Control) connection request to the base station (S201). The base station performs RRC Connection Setup (S202). An RRC connection is made between the terminal and the base station.

The terminal (UE) transmits an attach request (Attach Request) to the base station (eNodeB) by using the RRC Connection Setup Complete message (S203).

The base station (eNodeB) embeds an attach request in an initial UE message to be transmitted to the MME and transmits the initial UE message to the MME (S204). The initial UE message also includes a PDN connectivity request and the like. As a result of step S204, an S signaling connection is established between the base station (eNodeB) and the MME. Thereafter, an authentication/security procedure is performed (S205), the MME issues a location registration request (S206, S207) to the HSS, a bearer setup request to the S-GW (S208), and between the S-GW and the P-GW (S209. S210), S5 bearer between the S-GW and the P-GW is established and the S-GW returns a bearer setup response to the MME (S211), and the MME transmits a bearer setup response in the context setup request is transmitted to the base station (eNodeB) (S212).

The base station (eNodeB) causes an Attach Accept to be included in the RC connection reconfiguration (RRC Connection Reconfiguration) message, and transmits the Attach Accept to the terminal (UE) (S213). A data radio bearer (DRB) between the terminal (UE) and the base station (eNodeB) is established (S214) and the base station (eNodeB) returns a context setup response (S215), an Attach Complete is returned to the MME (S216). The MME updates the S1 bearer with the S-GW (S217, S218).

Thus, in a user plane (U-plane), the data radio bearer between the terminal and the base station, the S1 bearer between the base station and the S-GW, the S5 bearer between the S-GW and the P-GW are all established and the NAS Signaling connection (RRC Connection between terminal and base station, and S1 signaling connection between base station and MME) is established.

For example, the base station (eNodeB) may be configured to store the MEC service information included in the attach request (RRC Connection Setup Complete) transmitted from the terminal (UE) in step S203 in the memory 206, and for the terminal (UE) compatible with MEC service, the terminal with the data radio bearer established may be connected to the MEC server (S219). Note that connection setup processing between the terminal (UE) and the MEC server, in the base station (eNodeB) is not limited to after the completion of the attach procedure (S216) or the like, and may be performed at an arbitrary timing as long as the data radio bearer (DRB) between the terminal (UE) and the base station (eNodeB) has been established. According to Depending on a service to be provided, the MEC server may be connected to a packet data network via a P-GW of a core network.

In FIG. 9, when the MEC service is available, there is a case, wherein it is preferable that steps (or a part thereof) such as from the step S204, to the steps S212, S215, and S217 may be virtually executed between the base station and the MEC server, as processing of S219. The reason is that, when the MEC service is available, an actual service is not guided to the packet data network (PDN), so that the processing (or a part thereof) in the core network becomes unnecessary. Although it becomes redundant, these processing (or a part thereof) in the core networks may be also executed, but it is also possible to virtually execute equivalent processing between the base station and the MEC server. In the former case, it is preferable that the base station (eNodeB) does not relay Attach Complete in step S216 to the MME.

It is noted that the base station (eNodeB) does not necessarily have to analyze the information used for determining whether to receive the MEC service provided to the terminal (UE). For example, the MME that receives an Attach Request may perform the analysis of the information and send a notification to the base station. In this case, it is preferable that the base station virtually executes subsequent processing between the base station and the MEC server.

### <Example of Service Request>

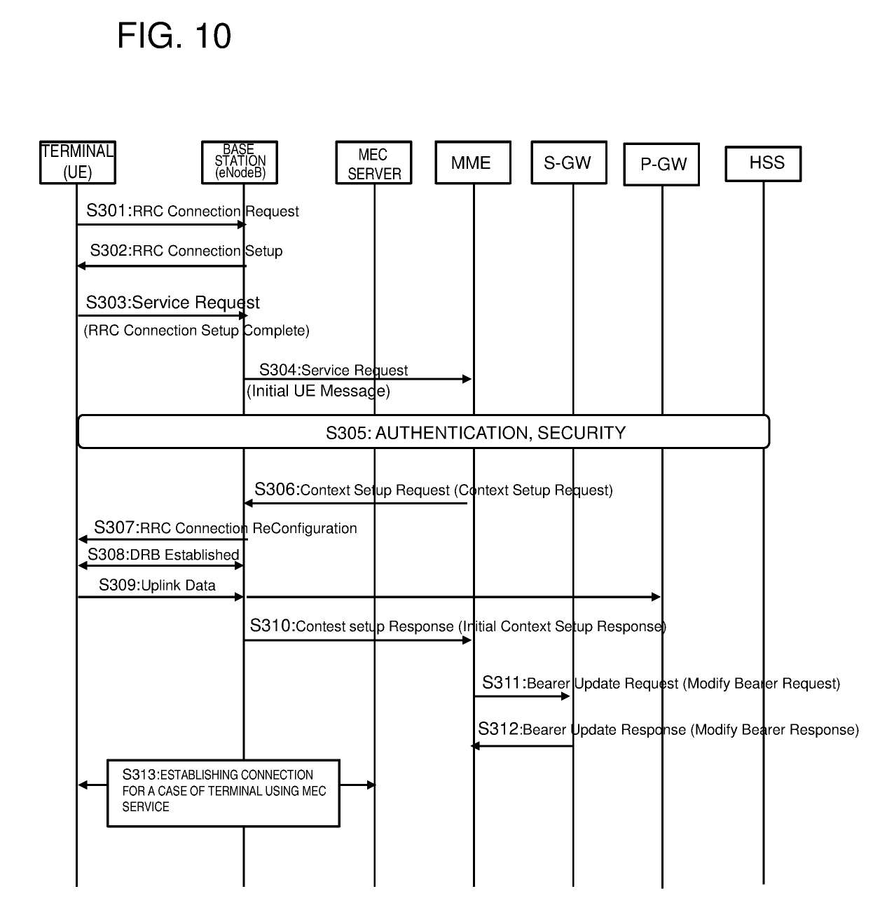

Alternatively, as illustrated in FIG. 10, a predetermined field of a service request (Service Request) message transmitted from the terminal (UE) to the base station (eNodeB) is analyzed to obtain information used to make a determination regarding provision of an MEC service. In FIG. 10, a procedure of a terminal initiated service request (UE triggered service request) is illustrated, but a service request (Network triggered Service Request) by a trigger from the network side is similarly applied.

When transmitting data from the terminal (UE) to a PDN side, the terminal (UE) transmits a service request (Service Request) to the base station (eNodeB) with an RRC Connection Setup Complete message (S303). Subsequently, the base station (eNodeB) puts the service request transmitted from the terminal (UE) in, for example, an initial UE message and transmits the Initial UE Massage to the MME (S304).

An authentication/security procedure is performed between the terminal (eNodeB), the MME, and the HSS (S305), and the MME transmits a context setup request to the base station (S306). The base station (eNodeB) transmits a RRC Connection Reconfiguration to the terminal (UE) (S307). A data radio bearer is established (S308), and the terminal (UE) transmits data to the PDN via the base station (eNodeB), the S-GW, and the P-GW (S309). The base station (eNodeB) transmits a context setup response to the MME (S310). The MME transmits a bearer update request to the S-GW (S311), and sets the S1 bearer with the S-GW. The S-GW returns a bearer update response (S312).

The base station (eNodeB) stores, in the memory 206, the MEC service information (information used to make a determination regarding provision of an MEC service) included in the service request (RRC Connection Setup Complete) that is transmitted from the terminal (UE) in step S303. In case where the terminal (UE) is compatible with the MEC service, the terminal with the data radio bearer established may be connected to the MEC server in step S308 (S 313). Depending on a service to be provided, the MEC server may be connected to a packet data network via the P-GW of the core network.

In FIG. 10, when the MEC service is available, there is a case, wherein it is preferable that steps (or a part thereof) such as from the step S304 to the steps S307, S310, and S311 may be virtually executed between the base station and the MEC server, as processing of S313. The reason is that, when the MEC service is available, an actual service is not guided to the packet data network (PDN), so that processing (or a part thereof) in the core network becomes unnecessary. Although it becomes redundant, these processing (or a part thereof) in the core networks may be also executed, but it is also possible to virtually execute equivalent processing between the base station and the MEC server. In the former case, it is preferable that the base station (eNodeB) does not transmit the context setup response in step S310 to the MME, for example, after transmission of the uplink data in S309.

It is noted that the base station (eNodeB) does not necessarily have to analyze the information used for determining whether to receive the MEC service provided to the terminal (UE). For example, the MME that receives a Service Request may perform the analysis of the information and send a notification to the base station. In this case, it is preferable that the base station virtually executes subsequent processing between the base station and the MEC server.

### <Example of PDN Connectivity Request>

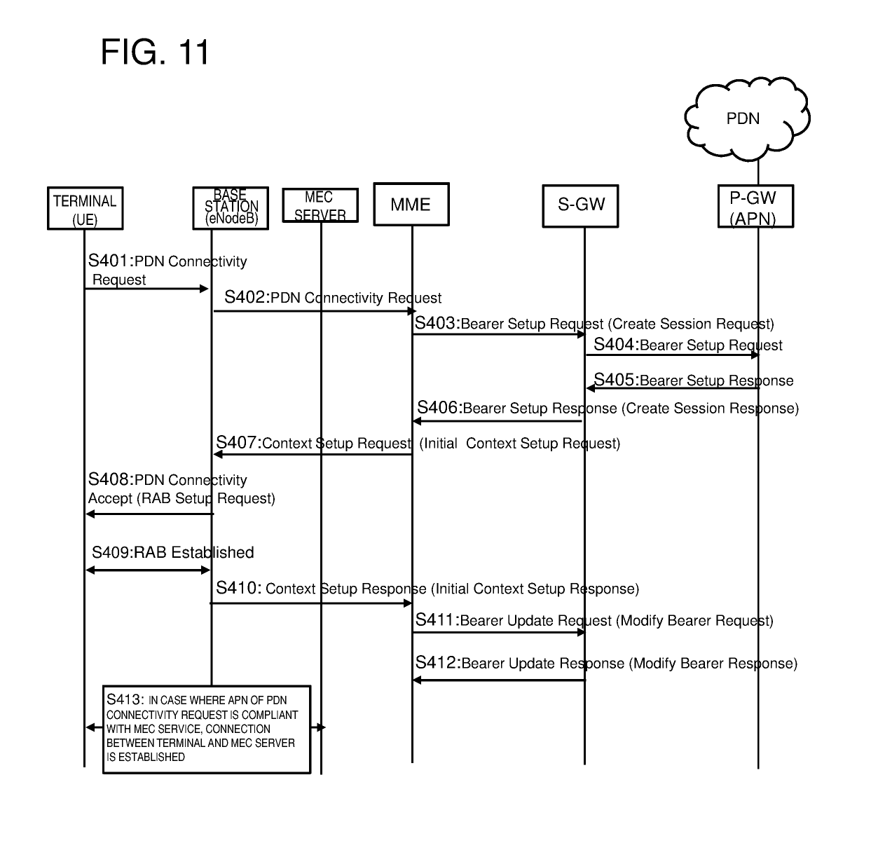

As illustrated in FIG. 11, from an access point name (APN) or the like of a PDN connectivity request message transmitted from the terminal (UE) to the base station (eNodeB), information used to make a determination regarding provision of an MEC service may be obtained. FIG. 11 is a diagram illustrating a PDP connectivity procedure requested by the terminal. Even if the terminal (UE) is being connected to a certain PDN via E-UTRAN, it can make a further connection request to the additional PDN.

When updating the PDN connectivity from the terminal (UE), the terminal (UE) transmits a PDN connectivity request message to the MME (S401, S402). The MME selects a new P-GW corresponding to the APN specified by the PDN connectivity request, transmits a bearer setup request to a new S-GW (S403). An S5 bearer is set between the new S-GW and the new P-GW (S404. S405). The MME receives a bearer setup response from the new S-GW (S406). The MME transmits a context setup request to the base station (eNodeB) (S407), and the base station (eNode B) transmits a radio bearer setup request (PDN Connectivity Accept) to the terminal (UE) (S408). The terminal (UE) transmits a radio bearer setup response to the base station (eNodeB) (S409), and the base station (eNode B) transmits a context setup response to the MME (S 410). The MME transmits a bearer update request to the S-GW (S411), and sets an S1 bearer with the S-GW. The S-GW returns a bearer update response (S412).

The base station (eNodeB) extracts an information element(s) such as an access point name (APN) included in the PDN connectivity request message transmitted from the terminal (UE) in step S401. In the present embodiment, when the information used to make a determination regarding provision of an MEC service is an access point name (APN), access point type (APN Type), and the like, the access point name (APN) and the access point type (APN Type) associated with an MEC server are previously stored in the memory (206 in FIG. 7). When the access point name (APN), access point type (APN Type) and the like included in the PDN connectivity request message transmitted from the terminal (UE), matches the information stored in the memory in advance, it is determined that the MEC service can be provided. For example, when an APN included in the PDN connectivity request message is an APN that is set and registered in the memory as that where the MEC service is available, a connection is established between the terminal (UE) and the MEC server (S413). In doing so, the base station (eNodeB) not only performs control of connection between the terminal (UE) and the MEC server from the access point name (APN) included in the PDN connectivity request message transmitted from the terminal (UE), but also the MEC server may perform control of connection between the terminal (UE) and the MEC server only as long as the MEC service information is included in the PDN connectivity request from the terminal (UE) and the MEC service is set to be available. Depending on a service to be provided, the MEC server may be connected to the packet data network (PDN) via a P-GW of a core network.

In FIG. 11, steps (or steps S407, S410, and S411) (or a part thereof) are virtually executed between the base station and the MEC server in the case where the MEC service is available, so that the step Processing may be preferable in some cases. The reason is that, in the case where the MEC service is available, the actual service is not guided to the packet data network (PDN), so that the processing (or a part thereof) in the core network becomes unnecessary. Although it becomes redundant, processing (or a part thereof) in these core networks is also executed, but it is also possible to virtually execute equivalent processing between the base station and the MEC server. In the former case, for example, it is preferable that the base station (eNodeB) does not relay the context setup response of step S410 to the MME.

It is noted that when the MEC service is available, there is a case, wherein it is preferable that steps (or a part thereof) such as from the step S402 to the steps S407, S410, and S311 may be virtually executed between the base station and the MEC server, as processing of 4313. The reason is that, when the MEC service is available, an actual service is not guided to the packet data network (PDN), so that processing (or a part thereof) in the core network becomes unnecessary. Although it becomes redundant, these processing (or a part thereof) in the core networks may be also executed, but it is also possible to virtually execute equivalent processing between the base station and the MEC server. In the former case, it is preferable that the base station (eNodeB) does not transmit the context setup response in step S410 to the MME, for example.

It is noted that the base station (eNodeB) does not necessarily have to analyze the information used for determining whether to receive the MEC service provided to the terminal (UE). For example, the MME that receives a PDN Connectivity Request in step S402 may perform the analysis of the information and send a notification to the base station. In this case, it is preferable that the base station virtually executes subsequent processing between the base station and the MEC server.

In the above, some examples of messages that are used by the notification unit 103 (FIG. 2) of the terminal 10 for notifying information to be used by a network node to make a determination regarding provision of an MEC service have been described. However, it is as a matter of course that the notification of the information used by a network node for determining whether to provide the MEC service is not limited to the messages described above. For example, the notification unit 103 of the terminal 10 may, as a matter of course, notify the network node of information used to make a determination regarding provision of an MEC service, by using a dedicated message. Further, in FIG. 7, the MEC information reception unit 203 of the base station 20 is not limited to a configuration that obtains information used to make a determination regarding provision of an MEC service from the message transmitted from the terminal 10. As illustrated in FIG. 6C, for example, the MEC information reception unit 203 of the base station 20 receives information (information for determining a terminal to which the MEC service is provided) transmitted from the server 31 connected to the PDN 30 For example.

The connection setting unit 205 may be implemented by a server virtualization technique such as SDN (Software Design Network), NFV (Network Function Virtualization), or the like.

As described above, the base station is described as an example of a network node that receives information for determining a terminal to which the MEC service is provided, determines a terminal to which the MEC service is provide, and establishes a connection between the terminal and the MEC server. However, the network node is not limited to the base station, but may be implemented by, for example, an MME or the like.

In the present embodiment, there may be such a configuration in which the terminal 10 is notified of whether or not the network node can provide the MEC service, by a signal of one of the following radio communication protocols. In each case, an ID assigned for the MEC service is given. For example, some number of bits of upper/lower digits may be set to 1/0, or set to a value of a predetermined range, and so on. For example, a predetermined number of bits of upper/lower digits out of
ECGI (E-UTRAN Cell Global Identifier) cellGlobalEUTRA
Physical Cell ID physCellId.
CSG (Closed Subscriber Group) ID, and so forth, each of which is included in mobility control information (mobility control IE: specified in 3 GPP TS 36.331 v 8.21.0 5.3.5.4 or 6.3.4) that is included in the RRC Connection Reconfiguration message, can be set to 1/0 when the MEC service can be provided.

The terminal (UE) may be configured such that when the terminal (UE) finds based on the above notification that the base station by which the terminal is served does not support an MEC service, a pop-up or the like is displayed on a display screen of the terminal, or that the terminal notifies a network node of information used to determine a terminal to which the MEC service is provided.

The notification of information from the terminal (UE) to the network may be made only when the MEC service is available, only when the MEC service is not available, or the like.

For the terminal that can use the MEC service, when the MME sets up a PDN connection or EPS bearer, the MME, by changing a PDN or APN where the MEC server is located may set up connection or EPS bearer between the MEC server and the terminal. In this case, the connection setup means in the base station becomes unnecessary. However, it is necessary to allocate in advance PDN and APN for the MEC server. The MME may store this information (allocation information of PDN or APN) and store correspondence between the normal PDN/APN and PDN/APN for MEC.

Connection between a MEC server installed/integrated in the vicinity of the network node, and a terminal of a user determined to use the MEC service based on information received, is set up. This can be realized by SDN. NFV or the like, but there is no way to specify how to set up a connection. An MEC located near the base station or ahead of the Internet may be selected.

The wireless communication system is exemplified by LTE, but may be W-CDMA (Wideband Code Division Multiple Access), 5 G (Fifth Generation), or the like. Signals, IE and so forth described in the embodiments of the present application may be replaced with equivalent ones.

Information used to make a determination regarding provision of an MEC service may be notified to a network node, using an RRC Connection Setup Complete message from the terminal 10 to the base station 20.

<Setting Example of a Message for Transferring Information Used for Determining a Terminal to which an MEC Service is Provided>

As described above, in the present embodiment, information used to make a determination regarding provision of an MEC service may be set in the following message, for example, and transmitted to the network (though it is not limited to the following).

1. RRC connection establishment:
RRC Connection Request
RRC Connection Setup Complete

### 2. RRC Connection Reconfiguration Complete:

3. UE capability information:
4. In addition, an RRC message for transmitting “information for determining a terminal to which a service is “from a terminal (UE) to a base station (eNodeB) may be defined.

Although not particularly restricted, as information used to make a determination regarding provision of an MEC service, for example, at least one of the following may be included (IE is an Information Element).
The terminal desire or requests the MEC service⇒mecServiceRequest-IE;
The terminal does not desire or request the MEC service⇒mecNoServiceRequest-IE; and
The terminal does not move from the predetermined area (serving cell)⇒mecNoMobility—IE.

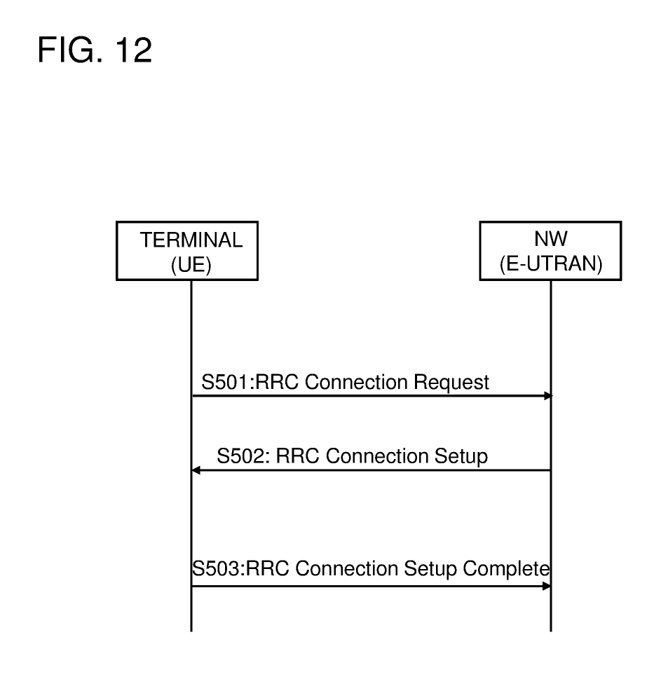

Referring to FIG. 12, using an RRC Connection Setup Complete message (S503) transmitted from the terminal (UE), the base station (eNodeB) having received the above information, transmits the configuration information for the MEC service to the terminal (UE) to be transmitted.

Information indicating “desiring or requesting MEC service” may be set in “MEC Service” in the Establishment Cause (information element indicating a cause of sending RRC Connection Request) of the RRC Connection Request message (S501) transmitted from the terminal (UE) to the E-UTRAN network node (base station).

When an MEC service is present, the RRC Connection Request is defined, for example, according to 3GPP TS 36.331 5.3.3.3, as follows ([ . . . ] indicates an omitted part).

RRCConnectionRequest-r8-IEs ::=SEQUENCE {

| | |
|---|---|
| ue-Identity | InitialUE-Identity, |

| | |
|---|---|
| establishmentCause | EstablishmentCause, |

| | |
|---|---|
| spare | BIT STRING (SIZE (1)) |

[...]

| | |
|---|---|
| EstablishmentCause ::= | ENUMERATED { |

emergency, highPriorityAccess, mt-Access, mo-Signalling,
mo-Data, delayTolerantAccess-v1020, MEC-Service}

}

For example, when an MEC service request is present, according to 3GPP TS 36.331 5.3.3.4, the configuration of the RRC Connection Setup Complete message (S503) in the terminal (UE) which has received the RRC Connection Setup may be defined as follows.

Contents of the RRC Connection Setup Complete message may be configured as follows.

If an upper layer has an MEC service request, mecServiceRequest provided in the upper layer may be set.

RRCConnectionSetupComplete message
[...]
RRCConnectionSetupComplete-vXXYY-IEs ::= SEQUENCE {

mecServiceRequest-rXX ENUMERATED {true}

| | |
|---|---|
| } | OPTIONAL, |

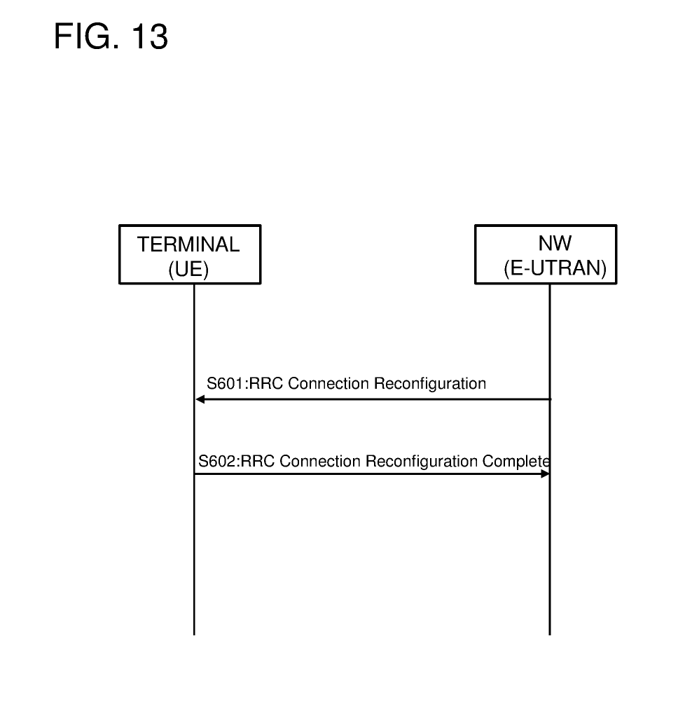

Referring to FIG. 13, an RRC Connection Reconfiguration message (S601) from an E-UTRAN network node (base station) to a terminal (UE) includes or does not include mobility control information. When the terminal is compliant (compatible) with a configuration included in this message, the terminal (UE) may set the content of a RRC Connection Reconfiguration Complete message (S602) as follows.

If the terminal (UE) has MEC service information, the terminal (UE) may set mecServiceRequest into the RRC Connection Reconfiguration Complete message. The RRC Connection Reconfiguration Complete message is used to confirm success completion of the RRC Connection Reconfiguration.

For example, when an MEC service request is present, according to 3GPP TS 36.331 5.3.5.3, the configuration of the RRC Connection Reconfiguration Complete message of the terminal (UE) that has received the RRC Connection Reconfiguration message may be defined as follows, for example.

If the RRC Connection Reconfiguration message includes or does not include mobilityControlInformation and the terminal (UE) complies with a configuration of the message, the RRC Connection Reconfiguration Complete message may be set as follows.

If the terminal has MEC service information, the terminal set mecServiceRequest.

RRCConnectionReconfigurationComplete message
[...]
RRCConnectionSetupComplete-vXXYY-IEs ::= SEQUENCE {

| mecServiceRequest-rXX ENUMERATED {true} | | OPTIONAL, |
|---|---|---|
| nonCriticalExtension | SEQUENCE { } | OPTIONAL |

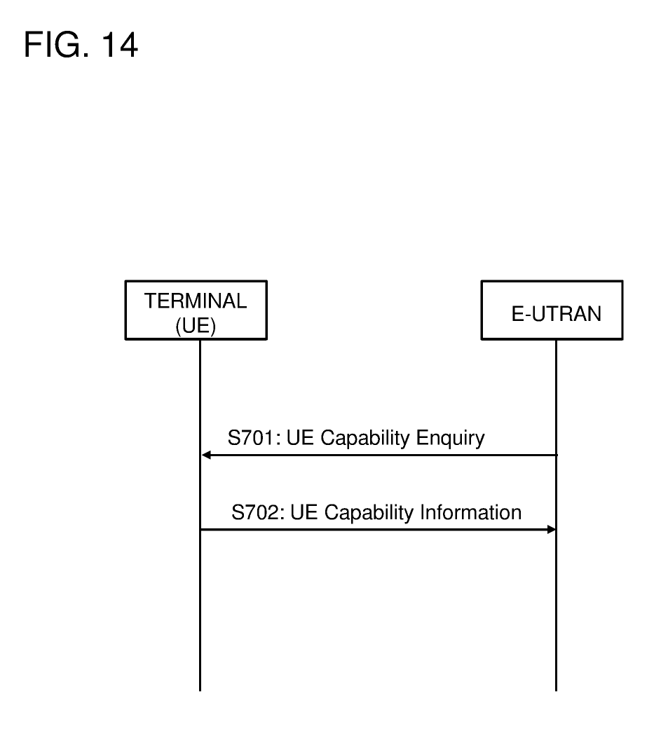

Referring to FIG. 14, information used to make a determination regarding provision of an MEC service may be configured in terminal capability information (UE capability information) (S702) which is transmitted from a terminal (UE) to an E-UTRAN network node (base station). The terminal capability information (UE capability information) is transmitted in response to an inquiry for terminal capability inquiry (UE capability Enquiry) (S701) transmitted from the base station (eNodeB) to the terminal.

“UE Category” and “MEC parameters” may be included in “UE-EUTRA-Capability” in the terminal capability information (UE capability information) as information used to make a determination regarding provision of an MEC service, and the terminal capability information (UE capability information) may be transmitted. The UE Category indicates that it is a terminal that can use the MEC service. MEC parameters indicate parameters of MEC that can be used in a terminal that can use the MEC service. When an MEC service request is present, the configuration of the UE capability information of the terminal UE (UE) that has received the terminal capability inquiry (UE capability Enquiry) according to 3GPP TS 36.331 5.6.3.3, may be configured as follows.

UE-EUTRA-Capability information element
[...]

| | |
|---|---|
| UE-EUTRA-Capability-vXXYY-IEs ::= | SEQUENCE { |

| | | |
|---|---|---|
| ue-Category-vXXYY | INTEGER | OPTIONAL, |

| | |
|---|---|
| mec-Parameters | MEC-Parameters |

| | | |
|---|---|---|
| nonCriticalExtension | SEQUENCE { } | OPTIONAL |

}

In any of the embodiments described above, it is made possible for a terminal to select provision of the MEC service. As a result, for example, by providing the MEC service to a terminal that can continuously receive the MEC service, decrease in customer satisfaction can be avoided or reduced.

Each of the above-described embodiments may be annexed, for example, as follows (but not limited to the following).

### (Supplementary Note 1)

A terminal comprising:

a user interface that accepts an input of information used to determine whether to receive provision of an MEC (Mobile Edge Computing) service or not; and

a notification unit configured to notify a network of information used by a network node to make a determination regarding provision of an MEC service.

### (Supplementary Note 2)

The terminal according to supplementary note 1, wherein the terminal displays a screen for accepting an input of information on the user interface, in at least any case of:

when an application that is a target of an MEC service operates;

when the terminal is powered on;

when the terminal resides in a new cell;

when the terminal moves across a location registration area;

when the terminal issues a location registration update request;

when the terminal establishes a connection with a packet data network; and

when a bearer of a core network is established.

### (Supplementary Note 3)

The terminal according to supplementary note 1 or 2, wherein the terminal displays a screen for selecting a usage scene of the terminal, as a screen for accepting an input of information on the user interface, and

the terminal uses information on the usage scene selected, as the information used to make a determination regarding provision of an MEC service.

### (Supplementary Note 4)

The terminal according to supplementary note 1, comprising

a setup screen for accepting an input of information on the user interface.

### (Supplementary Note 5)

The terminal according to supplementary note 4, wherein the terminal displays a screen for selecting at least one of:

use of the MEC service;

an area in which the MEC service is used;

a name of type of an access point through which the MEC service is used.

### (Supplementary Note 6)

The terminal according to any one of supplementary notes 1 to 5, wherein the notification unit puts information used by the network node to make a determination regarding provision of an MEC service in a predetermined request or response message of a mobility management or session management protocol to notify the network of the information.

### (Supplementary Note 7)

The terminal according to any one of supplementary notes 1 to 6, wherein the terminal puts information used by the network node to make a determination regarding provision of an MEC service in terminal capability information that is transmitted by the terminal in response to an inquiry from the network side to transmit the information.

### (Supplementary Note 8)

The terminal according to any one of supplementary notes 1 to 7, wherein the information used to determine whether to receive provision of the MEC service or not, include at least one of:

desiring/requesting the MEC service by the terminal;

not desiring/nor requesting the MEC service by the terminal; and

the terminal not moving from the predetermined area.

### (Supplementary Note 9)

The terminal according to any one of supplementary notes 1 to 8, wherein the terminal receives from the network side a notification indicating that MEC service provision is possible.

### (Supplementary Note 10)

A network node comprising:

a reception unit that receives from a terminal information used to make a determination regarding provision of an MEC (Mobile Edge Computing) service;

a determination unit that determines, based on the information received, a terminal to which the MEC service is provided; and

a connection setting unit that sets a connection of a terminal to which the MEC service is provided, with an MEC server.

### (Supplementary Note 11)

The network node according to supplementary note 10, wherein the terminal notifies the network node, of the information used by the network node to make a determination regarding provision of an MEC service included in a predetermined request or response message of a mobility management or session management protocol, and wherein the reception unit obtains information used to make a determination regarding provision of an MEC service from the request or response message.

### (Supplementary Note 12)

The network node according to supplementary note 11, wherein the terminal notifies a server of a packet data network via the network of information used to make a determination regarding provision of an MEC service, and wherein the reception unit receives information notified from the server to the network node for use in determining provision of the MEC service.

### (Supplementary Note 13)

The network node according to any one of supplementary notes 10 to 12, wherein the reception unit receives terminal capability information transmitted from the terminal and acquires information used to make a determination regarding provision of an MEC service, that is included in the terminal capability information.

### (Supplementary Note 14)

The network node according to any one of supplementary notes 10 to 13, wherein the information used to determine whether to receive provision of the MEC service or not, include at least one of:

desiring/requesting the MEC service by the terminal;

not desiring/nor requesting the MEC service by the terminal; and

the terminal not moving from the predetermined area.

### (Supplementary Note 15)

A network system comprising a terminal and a network node, wherein the terminal accepts an input of information used to determine whether to receive provision of an MEC service or not, and notifies the information to the network, and

the network node receives information used to determine whether to receive the provision of the MEC service from the terminal, determines a terminal to which the MEC service is provided, based on the information received, and

a connection of a terminal, to which the MEC service is provided, with an MEC server is set up.

### (Supplementary Note 16)

A communication control method in a network system including a terminal and a network node, the method comprising:

the terminal accepting an input of information used for determining whether to receive provision of an MEC service or not, and notifying the network of the information used by the network node to make a determination regarding provision of an MEC service;

the network node receiving information used for determining whether to receive provision of the MEC service from the terminal, and determining a terminal to which the MEC service is provided from the received information; and

setting a connection of a terminal, to which the MEC service is provided, with an MEC server.

### (Supplementary Note 17)

A communication control method of a terminal in a network system including the terminal and a network node, the method comprising:

accepting an input of information used to determine whether to receive provision of an MEC (Mobile Edge Computing) service or not; and

notifying a network of information used by the network node to make a determination regarding provision of an MEC service.

### (Supplementary Note 18)

A communication control method of a network node in a network system including a terminal and the network node, the method comprising:

the network node receiving from the terminal information used to make a determination of provision of an MEC service;

determining a terminal, to which the MEC service is provided, based on the information received; and

setting a connection of a terminal to which the MEC service is provided, with an MEC server.

### (Supplementary Note 19)

A non-transitory computer-readable medium storing therein a program causing a computer constituting a terminal to execute processing comprising:

accepting an input of information used to determine whether to receive provision of an MEC (Mobile Edge Computing) service or not; and

notifying a network of information used by a network node to make a determination regarding provision of an MEC service.

### (Supplementary Note 20)

A non-transitory computer-readable medium storing therein a program causing a computer constituting a network node to execute processing comprising:

receiving from a terminal information used to make a determination of provision of an MEC service;

determining a terminal to which the MEC service is provided, based on the information received; and

setting a connection of a terminal to which the MEC service is provided, with an MEC server.

### (Supplementary Note 21)

A server apparatus connected to a network node that is configured to receive, from a terminal, information used to make a determination of provision of an MEC service, and determines a terminal to which the MEC service is provided, based on the information received, wherein the server provides the MEC service to a terminal to which the MEC service is provided, using connection setting set by the network node.

The disclosure of each of the above Patent Literature 1 and Non-Patent Literature 1 and 2 is incorporated herein by reference thereto. Variations and adjustments of the Exemplary embodiments and examples are possible within the scope of the overall disclosure (including the claims) of the present invention and based on the basic technical concept of the present invention. Various combinations and selections of various disclosed elements (including the elements in each of the claims, examples, drawings, etc.) are possible within the scope of the claims of the present invention. Namely, the present invention of course includes various variations and modifications that could be made by those skilled in the art according to the overall disclosure including the claims and the technical concept.

1. A terminal comprising:
a user interface that accepts an input of information used to determine whether to receive provision of an MEC (Mobile Edge Computing) service from an MEC server, or not; and
a notification unit configured to notify a network of information used by a network node to make a determination regarding provision of an MEC service from the MEC server.

2. The terminal according to claim 1, wherein the terminal displays a screen for accepting an input of information, on the user interface, in at least one case of:
when an application that is a target of an MEC service operates;
when the terminal is powered on;
when the terminal resides in a new cell;
when the terminal moves to another location registration area;
when the terminal issues a location registration update request;
when the terminal establishes a connection with a packet data network; and
when a bearer of a core network is established.

3. The terminal according to claim 1, wherein the terminal displays a screen for selecting a usage scene of the terminal, as a screen for accepting an input of information on the user interface, and
the terminal uses information on the usage scene selected, as the information used to make a determination regarding provision of the MEC service.

4. The terminal according to claim 1, comprising
a setup screen for accepting an input of information on the user interface.

5. The terminal according to claim 4, wherein the terminal displays a screen for selecting at least one of:
use of the MEC service;
an area in which the MEC service is used; and
a name or a type of an access point which uses the MEC service.

6. The terminal according to claim 1, wherein the notification unit puts information used by the network node to make a determination regarding provision of an MEC service, in a predetermined request or response message of a mobility management or session management protocol to notify the network of the information.

7. The terminal according to claim 1, wherein the terminal puts information used by the network node to make a determination regarding provision of an MEC service, in terminal capability information that is transmitted by the terminal in response to an inquiry from the network side to transmit the information.

8. A network node comprising:
a reception unit that receives from a terminal information used to make a determination regarding provision of an MEC (Mobile Edge Computing) service from an MEC server,
a determination unit that determines, based on the information received, a terminal to which the MEC service is provided from the MEC server; and
a connection setting unit that sets a connection of a terminal to which the MEC service is provided, with the MEC server.

9. A communication control method of a terminal in a network system including the terminal and a network node, the method comprising:
accepting an input of information used to determine whether to receive provision of an MEC (Mobile Edge Computing) service from an MEC server, or not; and
notifying a network of information used by the network node to make a determination regarding provision of an MEC service from the MEC server.

10. A communication control method of a network node in a network system including a terminal and the network node, the method comprising:
the network node receiving from the terminal information used to by the network node to make a determination regarding provision of an MEC service from an MEC server,
determining a terminal, to which the MEC service is provided from the MEC server, based on the information received; and
setting a connection of a terminal to which the MEC service is provided, with the MEC server.

11. A non-transitory computer readable medium storing therein a program causing a computer constituting a terminal to execute processing comprising:
accepting an input of information used to determine whether to receive provision of an MEC (Mobile Edge Computing) service from an MEC server, or not; and
notifying a network of information used by a network node to make a determination regarding provision of an MEC service from the MEC server.

12. A non-transitory computer readable medium storing therein a program causing a computer constituting a network node to execute processing comprising:
receiving from a terminal information used to make a determination of provision of an MEC service from an MEC server;
determining a terminal to which the MEC service is provided from the MEC server, based on the information received; and
setting a connection of a terminal to which the MEC service is provided, with the MEC server.
